(19) United States
(12) Patent Application Publication
(10) Pub. No.: US 2025/0165979 A1
(43) Pub. Date: May 22, 2025

(54) IDENTIFY FRAUDULENT USE OF PAYMENT METHODS BASED ON A PORTION OF THEIR PRIVATE UNIQUE CODES

(71) Applicant: nSure.ai Payment Assurance Ltd., Tel-Aviv (IL)

(72) Inventors: Ziv ISAIAH, Tel-Aviv (IL); Doron David DINAI, Tel Aviv (IL)

(73) Assignee: nSure.ai Payment Assurance Ltd., Tel-Aviv (IL)

(21) Appl. No.: 18/515,388

(22) Filed: Nov. 21, 2023

(51) Int. Cl. G06Q 20/40

(52) U.S. Cl. CPC G06Q 20/4016; G06Q 20/4014; G06Q 20/4018

(57) ABSTRACT

A method of detecting potential fraudulent use of identification (ID) items, comprising receiving a partial code of a unique code of each of a plurality of ID items used in a plurality of identification events each associated with timing data, identifying pairs of first and corresponding identification events in which the ID items used have an identical partial code, estimating whether the ID item used in the first identification event of each pair and the ID item used in the corresponding second identification event of the respective pair are different ID items or the same ID item based on whether a time period between the first and second identification events exceeds or not, respectively, a certain time interval, and generating notification(s) indicative of a potential fraudulent use of the same ID item responsive to estimating the same ID item is used in the first and second identification events.

### BACKGROUND

The present invention, in some embodiments thereof, relates to detecting potential fraudulent use of identification (ID) items, and, more specifically, but not exclusively, to detecting potential fraudulent use of ID items by estimating whether the ID used in multiple identification are the same or different based on a time elapsing between the events without exposing their full private unique codes.

ID items are used for identifying their users, their resources, and/or accounts in a plurality of applications ranging from payment cards used to make financial transactions, through online services requiring access credentials, email addresses, phone numbers, etc. for users identification and/or authentication, to ID tags, fobs and/or keys for physical access to secure locations and/or facilities.

Such ID items are constantly subject to fraudulent use by malicious parties maliciously impersonating as legitimate users in attempt to gain access to and/or compromise resources, funds, physical assets, secret, sensitive, and/or private information, and/or the like.

### SUMMARY

According to a first aspect of the present invention there is provided a method of detecting potential fraudulent use of identification (ID) items, comprising using one or more processors for:
Receiving a partial code of a unique code of each of a plurality of ID items used in a plurality of identification events each associated with timing data.
Identifying one or more pairs of a first identification event and a corresponding second identification event of the plurality of plurality of identification events in which the ID items used have an identical partial code.
Estimating the ID item used in the first identification event of each pair and the ID item used in the corresponding second identification event of the respective pair are different ID items in case a time period between the first and second identification events exceeds a certain time interval.
Estimating the ID item used in the first identification event of the respective pair is the same ID item used in the second identifications event of the respective pair in case the time period does not exceed the certain time interval.
Generating, responsive to estimating the same ID item is used in the first and second identification events of one or more pairs, one or more notifications indicative of a potential fraudulent use of the same ID item.

According to a second aspect of the present invention there is provided a system for detecting potential fraudulent use of identification (ID) items, comprising one or more processors configured to execute a code. The code comprising:
Code instructions to receive a partial code of a unique code of each of a plurality of ID items used in a plurality of identification events each associated with timing data.
Code instructions to identify one or more pairs of a first identification event and a corresponding second identification event of the plurality of plurality of identification events in which the ID items used have an identical partial code.
Code instructions to estimate the ID item used in the first identification event of each pair and the ID item used in the corresponding second identification event of the respective pair are different ID items in case a time period between the first and second identification events exceeds a certain time interval.
Code instructions to estimate the ID item used in the first identification event of the respective pair is the same ID item used in the second identifications event of the respective pair in case the time period does not exceed the certain time interval.
Code instructions to generate, responsive to estimating the same ID item is used in the first and second identification events of one or more pairs, one or more notifications indicative of a potential fraudulent use of the same ID item.

In a further implementation form of the first, and/or second aspects, the plurality of ID items comprise a plurality of payment cards used in a plurality of financial transactions, the unique code associated with each plurality of the plurality of payment cards comprises a primary account number (PAN) code comprising a string of digits, and the partial code of each plurality of payment cards comprises part of the string of digits of the PAN of the respective payment card.

In a further implementation form of the first, and/or second aspects, the partial code of at least some of the plurality of payment cards further comprises a bank identification number (BIN) and/or an issuer identification number (IIN) of the respective payment card.

In a further implementation form of the first, and/or second aspects, the partial code of each of the plurality of payment cards further comprises an expiration date of the respective payment card.

In a further implementation form of the first, and/or second aspects, the plurality of ID items comprises a plurality of user ID tags associated with a plurality of users used in a plurality of user identification events.

In a further implementation form of the first, and/or second aspects, the plurality of ID items comprises a plurality of account IDs associated with a plurality of users and used in a plurality of user identification events.

In a further implementation form of the first, and/or second aspects, the certain time interval is predefined based on a statistical analysis of a frequency of a plurality of identification events conducted using at least some of the plurality of ID items.

In a further implementation form of the first, and/or second aspects, the certain time interval is adjusted according to an estimation error tolerance.

In a further implementation form of the first, and/or second aspects, the plurality of ID items are issued by a plurality of issuers, the certain time interval is predefined respectively for each of the plurality of issuers.

In a further implementation form of the first, and/or second aspects, the certain time interval is predefined according to one or more attributes of the plurality of identification events.

In an optional implementation form of the first, and/or second aspects, the estimation of whether the ID item used in the one or more first identification event is the same ID item used in the one or more second identification events or a different ID item is based on one or more additional ID items associated with the ID item.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of detecting potential fraudulent use of ID items, according to some embodiments of the present invention; and

FIG. 2 is a schematic illustration of an exemplary system for detecting potential fraudulent use of ID items, according to some embodiments of the present invention.

### DETAILED DESCRIPTION

The present invention, in some embodiments thereof, relates to detecting potential fraudulent use of identification (ID) items, and, more specifically, but not exclusively, to detecting potential fraudulent use of ID items by estimating whether the ID used in multiple identification are the same or different based on a time elapsing between the events without exposing their full private unique codes.

ID items are used for a plurality of identification and/or authentication applications. For example, payment cards (e.g., credit cards, debit cards, member cards, etc.) associated with bank accounts may be used as ID items for conducting financial transactions. In another example, ID tags may be used for physical access to restricted and/or limited access locations, facilities, and/or the like. In another example, credentials, email addresses, phone numbers, user names, and/or the like may be used for accessing online services, accounts, systems, and/or platforms.

Malicious parties having access to such ID items of legitimate users and/or information thereof may attempt to use these ID items to fraudulently access the users' resources, accounts, funds, secret and/or private information, physical assets, and/or the like.

While each such ID item is typically associated with a unique code based on which the ID item may be distinguished among the plurality of ID items, this unique code is secret and not publicly distributed for the obvious reasons of preventing their malicious duplication and fraudulent use. For example, strict regulatory driven rules and/or policies such as, for example, Payment Card Industry Data Security Standard (PCI DSS) may apply to security of payment cards used for financial transactions.

During identification events in which the ID items are used, for example, financial transactions using payment cards, user identification events using ID tags and/or account IDs, and/or the like, only part of the unique secret code of the ID items may be exposed while the rest of the unique code, typically the majority of the code, is kept secret.

For example, each payment card may be associated and/or assigned a unique code comprising, for example, a Bank Identifier Number (BIN), also known as Issuer Identifier Number (IIN), and a series of digits unique to the respective payment card. During a financial transaction using a payment card, according to the PCI DSS, the unique code of the payment card is not publicly exposed and/or shared with non-compliant entities, for example, the merchant. Rather, only the BIN, the four last digits, and optionally an expiration date of the payment card may be exposed while the reminder of the unique code is not revealed. In another example, during identification and/or authentication events of users accessing online services, users may provide account ID to verify their identity but only part of their account ID may be exposed, for example, a prefix and some digits of their phone number, a domain name and same characters of their email account (address), and/or the like.

As such, a plurality of different ID items, each having a different unique code, may share an identical partial code, i.e., the portion of their unique code which is exposed during the identification events may be the same.

It may be therefore a major challenge to detect whether the same ID item or several different ID items sharing the same partial code were used in a plurality of different identification events.

According to some embodiments of the present invention, there are provided methods, systems, devices and computer program products for estimating whether ID items having identical partial codes which are used in multiple identification events are the same or different based on their a time period elapsing between such identification events, interchangeably designated collisions herein after.

In particular, legitimate identification events conducted by legitimate and/or genuine users may be distinguished from potential fraudulent identification events based on usage patterns of the ID items which may be expressed and/or identified according to a time frame of these collisions, for example, a time period elapsing between multiple identification events in which the ID item used have the same (identical) partial code.

For example, the probability that two or more different ID items having the same partial code may be used within a short period of time is significantly lower compared to the probability such an occurrence over a longer time period. For example, the probability that multiple payment cards having the same partial code are used within a time interval of 10 minutes may be significantly low while the probability that multiple payment cards having the same partial code are used within a time interval of 10 months may be significantly high.

Therefore, since it is highly unlikely that multiple different ID items having the same partial code are used in contiguous identification events which are spaced from each other by a certain short time interval, such a use pattern may be highly indicative of a fraudulent use of the same ID item in one or more of the identification events. For example, fraudulent use of payment cards is typically characterized by conducting a plurality of financial transactions in short time period to prevent tracking and capture.

The time period which elapses between collisions, i.e., a plurality of identification events in which the ID items used have identical partial codes, may be therefore evaluated compared to a certain time interval. In case the time period exceeds the certain time interval, it may be estimated that different ID items which happen to have the same partial code were used in these identification events. However, in case the time period does not exceed the certain time interval, it may be estimated that the same ID item was used in these identification events which may be indicative of potential fraudulent use of the ID item.

Optionally, the certain time interval may be set, defined, predefined, and/or adjusted according to one or more attributes, parameters, and/or characteristics relating to the identification events, the ID items, the application for which the ID items are used, and/or the like. For example, the certain time interval may be set, and/or adjusted according to a statistical analysis on the frequency of the identification events, and/or the frequency of collisions. For example, the certain time interval may be reduced for highly frequent identification events, for example, financial transaction using payment cards. In another example, the certain time interval may be increased for low frequency identification events, for example, access to secure facility using ID tags.

Optionally, estimation of whether the same ID item was used in one or more one or more identification events and corresponding subsequent events is further based on one or more additional ID items associated with the used ID item. For example, assuming that a payment card used in multiple subsequent financial transactions has the same partial code, in addition to the elapsed time between these identification events, estimation of whether the payment card is the same or a different one may be further done based on an additional ID item exposed and/or shared during these identification events, for example, an account ID (e.g., email address, phone number, etc.).

Estimating fraudulent use of ID items based on their partial codes and time spacing may present significant advantages and benefits compared to existing methods for fraud detection.

First, since typically the complete unique code of the ID items is not exposed during the identification events, it may be difficult and even impossible to determine whether the same ID item or different ID items were used in these identification events and detect fraudulent use accordingly. Therefore, taking advantage of the partial codes which are publicly exposed during the identification events to distinguish between identification events in which the same ID item is used and identification events in which different ID items based on the time period between these identification events may significantly increase performance of fraud detection, for example, accuracy, reliability, and/or robustness.

Moreover, fraud detection systems adapted to detect potential fraudulent use of the ID items based on their partial codes do not have access and thus do not store the full unique codes of the ID items as may be done by existing methods. Therefore, compared to the existing methods, such fraud detection systems may be significantly more immune to cyberattacks launched in attempt to gain access to the ID items' unique secret codes and fraudulently use them. However, while highly immune and robust against cyberattacks, such fraud detection systems may maintain high fraud detection performance, for example, accuracy, reliability, and/or robustness.

Furthermore, adjusting the certain time interval according to the application using the ID items, according to attributes of the identification events, and/or according to attributes of an issuer of the ID items may allow adjustment, adaptation, and/or customization for specific applications, deployment scenarios, and/or use cases thus further increasing performance of fraud detection in the specific environment.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

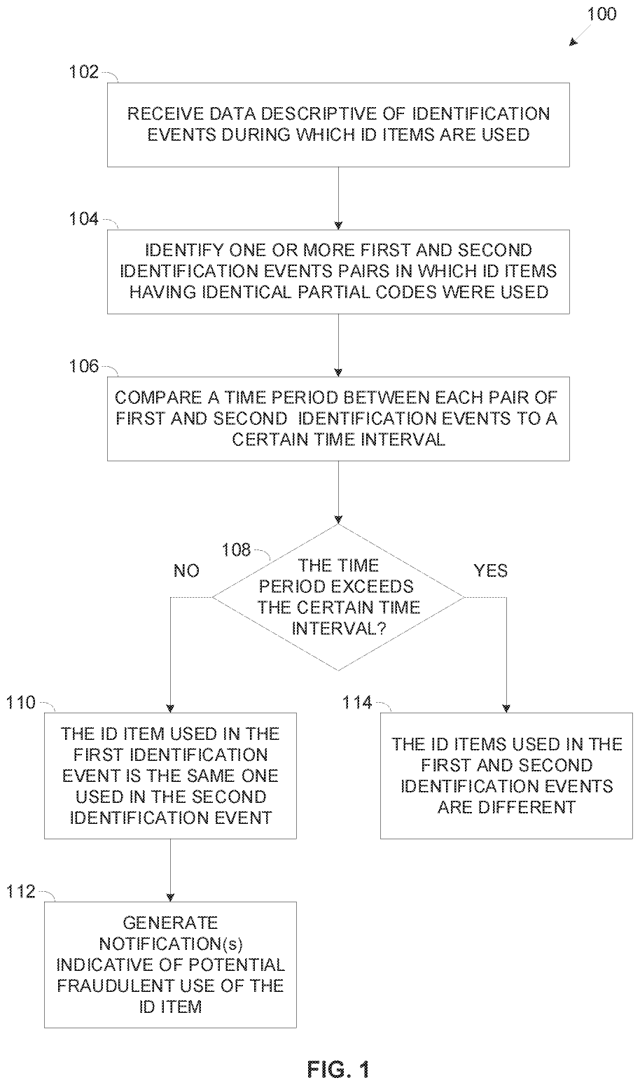

Referring now to the drawings, FIG. 1 is a flowchart of an exemplary process of detecting potential fraudulent use of ID items, according to some embodiments of the present invention.

An exemplary process 100 may be executed to estimate whether ID items used in a plurality of identification events, for example, financial transactions using payment cards, user ID tags, users digital and/or online accounts and/or the like, specifically contiguous identification events, are the same ID items which may be indicative of a fraudulent use of such ID items.

Each such ID item is associated with a unique secret code such that it may be deterministically identified and verified. However, during the identification events, only a portion, i.e., part of the code may be publicly exposed while the complete secret code is kept secret.

The estimation of whether the same ID item is used in multiple contiguous identification events may be therefore based on analysis of the portion of the code, interchangeably designated partial code herein, which is exposed during the identification events.

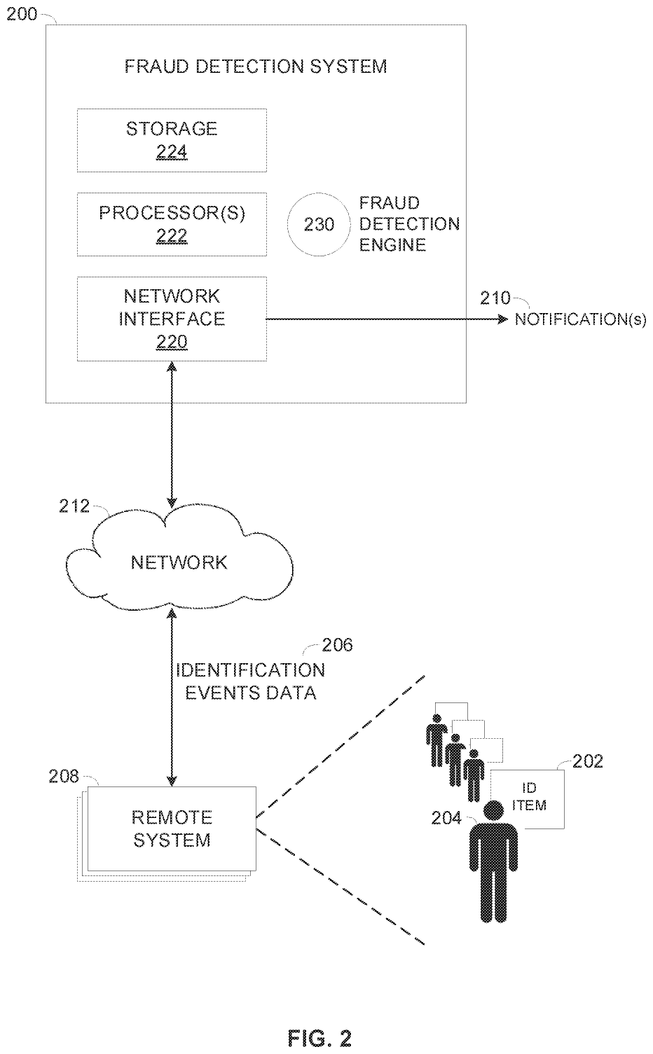

Reference is also made to FIG. 2, which is a schematic illustration of an exemplary system for detecting potential fraudulent use of ID items, according to some embodiments of the present invention.

An exemplary fraud detection system 200 may be adapted to execute a process such as the process 100 for detecting potential fraudulent use of ID items 202, typically associated with respective users 204, in a plurality of identification events.

The fraud detection system 200 may receive identification events data 206 which is descriptive of the plurality of identification events during which the ID items 202 are used, typically by the users 204. The identification events data 206 may be received, for example, from one or more remote systems 208 which manage, control, and/or relate to the identification and/or ID verification process of the used ID items 204.

In response to determining that one or more ID items 202 may be fraudulently used in one or more identification events, the fraud detection system 200 may output, generate, transmit, and/or otherwise provide one or notifications 210 indicative of the potential fraudulent use of ID item(s) 202.

The fraud detection system 200, for example, a server, a computing node, a cluster of computing nodes and/or the like may include a network interface 220, a processor(s) 222, and a storage 224 for storing data and/or code (program store).

The network interface 220 may comprise, for example, one or more wired and/or wireless interfaces, ports, and/or links, implemented in hardware, software, and/or combination thereof, for connecting to a network 212 comprising one or more wired and/or wireless networks, for example, a Local Area Network (LAN), a Wireless LAN (WLAN, e.g., Wi-Fi), a Wide Area Network (WAN), a Municipal Area Network (MAN), a cellular network, the internet, and/or the like.

Via the network interface 220, the fraud detection system 200 may communicate with one or more of the remote systems 208, for example, a remote server, a storage server, a cloud service, and/or the like to receive the identification events data 206 and/or transmit the notification(s) 210.

The processor(s) 222, homogenous or heterogeneous, may include one or more processing nodes arranged for parallel processing, as clusters and/or as one or more multi core processor(s).

The storage 224 may include one or more non-transitory memory devices, for example, persistent devices such as, for example, a ROM, a Flash array, a hard drive, a Solid State Disk (SSD), and/or the like, as well as volatile devices such as, for example, a RAM device, a cache memory and/or the like. The storage 224 may further comprise one or more local and/or remote network storage resources, for example, a storage server, a Network Attached Storage (NAS), a network drive, a cloud storage service and/or the like accessible via the network interface 220.

The processor(s) 222 may execute one or more software modules, for example, a process, a script, an application, an agent, a utility, a tool, an Operating System (OS), a service, a plug-in, an add-on, and/or the like each comprising a plurality of program instructions stored in a non-transitory medium (program store) such as the storage 224 and executed by one or more processors such as the processor(s) 222.

Optionally, the processor(s) 222 may further include, utilize and/or apply one or more hardware elements available to the fraud detection system 200, for example, a circuit, a component, an Integrated Circuit (IC), an Application Specific Integrated Circuit (ASIC), a Field Programmable Gate Array (FPGA), a Digital Signals Processor (DSP), a Graphic Processing Unit (GPU), an Artificial Intelligence (AI) accelerator, and/or the like.

The processor(s) 222 may therefore execute one or more functional modules utilized by one or more software modules, one or more of the hardware modules and/or a combination thereof. For example, the processor(s) 222 may execute a fraud detection engine 230 adapted for executing the process 100.

Optionally, the fraud detection system 200, specifically, the fraud detection engine 230 may be utilized by one or more cloud computing services, platforms and/or infrastructures such as, for example, Infrastructure as a Service (IaaS), Platform as a Service (PaaS), Software as a Service (SaaS) and/or the like provided by one or more vendors, for example, Google Cloud Platform (GCP), Microsoft Azure, Amazon Web Service (AWS) and Elastic Compute Cloud (EC2), IBM Cloud, and/or the like. These cloud computing services may be adapted to receive the identification events data 206 and/or transmit the notification(s) 210 in response to detecting potential fraudulent use of the ID items 202.

As shown at 102, the process 100 starts with the fraud detection engine 230 receiving identification events data 206 descriptive of a plurality of identification events in which ID items 202 are used, typically by associated users 204.

In particular, each of the identification events may be associated in the identification events data 206 with a respective ID item 202 used in the respective identification event and timing data relating to the respective identification event.

The timing data may include for example, a timestamp indicating the time of occurrence of the respective identification event occurred, i.e., the time when the respective identification event took place. The resolution of timing of the identification events, for example, the timestamp, may depend on one or more parameters, attributes and/or characteristics of the identification events and may be set, selected, and/or defined in one or more time units, for example, milliseconds, seconds, minutes, hours, and/or the like.

Each of the ID items 202 may be assigned and/or associated with a unique secret code (key). However, in order to maintain security, safety, and/or privacy of the ID items only a portion (part), interchangeably designated partial code herein, of the unique code is exposed during the identification events.

For example, according to some embodiments, the plurality of ID items 202 may comprise a plurality of payment cards used in a plurality of financial transactions. In such case, the unique code associated with each plurality of the plurality of payment cards may comprise, for example, a Primary Account Number (PAN) code, also known simply as card number.

The PAN, which comprises a string of digits uniquely identifying the specific payment card, is primarily a card identifier (ID) which may or may not directly identify the bank account number to which the payment card is linked by the issuer (issuing entity) of the payment card. The prefix of the PAN of each payment card typically identifies the issuer, and the digits that follow are used to identify the respective user 204 (cardholder) as a customer and which associated by the issuer with the designated bank account(s) of the respective user 204. PAN numbers may be allocated in accordance with ISO/IEC 7812.

In such embodiments, the portion of the PAN, i.e., the partial code of each payment card may comprise a portion (part) of the string of digits of the PAN of the respective payment card, for example, the last 4 digits, the last 6 digits and/or the like.

Optionally, the partial code of one or more of the payment cards may further comprise a Bank Identification Number (BIN) and/or an Issuer Identification Number (IIN) of the respective payment card. Optionally, the partial code of one or more of the payment cards may also include an expiration date of the respective payment card.

The identification events data 206 relating to use of the plurality of payment cards may therefore include the partial code of each of the payment cards used for one or more of the financial transactions. For example, the partial code of each payment card may comprise its BIN+Last 4 digits+expiration data.

The fraud detection engine 230 may receive this identification events data 206 from one or more remote systems controlling, managing, and/or monitoring the financial transactions, for example, a banking service, a financial service system, (e.g., Visa, American Express, Diners, etc.), a defrayal system, an Automated Teller Machine (ATM) system, and/or the like.

Such financial transactions systems, which may typically utilize one or more token based protocols for authenticating, authorizing, and/or verifying the payment cards may be exposed to at least part of the PAN of the payment cards used in the transactions, specifically the partial codes of the payment cards. Token based protocols and methods in which unique tokens is created and distributed to end systems to replace the actual PAN of payment cards used for the transactions, typically for each individual transaction, are known in the art and is out of scope of the present disclosure.

In another example, the plurality of ID items 202 may comprise a plurality of user ID tags associated with a plurality of users 204 which may use the ID tags in a plurality of user identification events to identify and/or authenticate themselves. For example, users 204 such as, for example, personal authorized to enter a secure facility, may authenticate themselves using respective personal ID tags which may be scanned to verify their identity and access permission before allowing them to enter the facility.

The ID tags, for example, a Radio Frequency (RFID) tag, a QR code tag, a barcode, tag, and/or the like, may be each assigned and/or allocated with a unique code which may be stored, printed, marked, and/or otherwise embedded in the ID tag. The unique secret code of each ID tag may be utilized, expressed, and/or encoded using one or more methods, techniques, and/or representations, for example, one or more numeric codes, one or more strings comprising a plurality of digits, characters, and/or symbols, a visual code such as QR code, barcode, etc., a combination thereof and/or the like.

The identification events data 204 relating to use of the plurality of ID tags may therefore include partial codes, i.e., portion of the unique code, of the ID tags used for authenticating users 204 in the plurality of identification events. For example, assuming a plurality of ID tags, for example, RFID tags associated with users 204 for authenticating the users 204 in identification events, are each assigned a respective unique code comprising a string of 32 digits and characters. In such case the partial code of each of the RFID tags may comprise a portion of the receptive unique code of the respective RFID tag, for example, the 6 or 8 first digit and/or characters of the string, and/or the like.

The fraud detection engine 230 may receive this identification events data 206 from one or more remote systems controlling, managing, and/or monitoring authentication, authorization and/or verification of the ID tags during the identification events, for example, an ID tags scanner, an authentication system, an identity monitoring system, and/or the like.

In another example, the plurality of ID items 202 may comprise a plurality of account IDs, for example, a phone number, an email address, an account ID, and/or the like associated with a plurality of users 204 who may use the account IDs for accessing one or more services, systems, and/or platforms, collectively designated services, typically online services. Such accounts IDs may be used as ID items even before verified and more so after verified and successfully associated with users 204 according to one or more account verification methods known in the art.

Such account IDs are unique per users 204 and may be thus constructed, composed, and/or assigned of a code which is typically not easily accessible in the public domain, for example, a phone number, an email address, an account ID, access credentials, a password, an access key, and/or the like which may thus serve as unique codes.

The identification events data 206 relating to use of the plurality of account IDs may therefore include partial codes, i.e., a portion of the unique code, of the account IDs used for authenticating users 204 in the plurality of identification events. For example, assuming a certain account ID comprises an email address of a certain user 204 using the email address for accessing an online service, for example, a social network. In such case, the partial code of the certain account ID may comprise the first two characters, digits, and/or symbols of the local part and the domain part of the email address. In another example, assuming a certain account ID comprises an phone number of a certain user 204 using the email address for accessing an online service, for example, a bank account. In such case, the partial code of the certain account ID may comprise the initial digits indicating the area code or the operator ID and the 4 last digits of the phone number.

The fraud detection engine 230 may receive this identification events data 206 from one or more remote systems controlling, managing, and/or monitoring authentication, authorization and/or verification of the account IDs during the identification events, for example, an authentication service, an accessed online service, and/or the like.

As shown at 104, the fraud detection engine 230 may analyze the identification events data 206 to identify one or more first identification events and one or more second identification events of the plurality of plurality of identification events in which the ID items 202 used have an identical partial code.

In particular, the fraud detection engine 230 may analyze the identification events data 206 to identify one or more pairs of identification events, interchangeably designated collisions. Each such pair may comprise a first identification event and a corresponding subsequent second identification event in which the ID items 202 that were used have the same partial code.

Obviously, a second identification event of a certain pair may be the first identification event of another pair comprising a subsequent identification event in which the ID item 202 that was used has the same partial code, which is thus considered the corresponding second identification event of the another pair.

For example, assuming the identification events relate to financial transactions in which payment cards are used, the fraud detection engine 230 may identify two or more financial transactions in which the payment cards that were used have the same partial code. In another example, assuming the identification events relate to financial transactions in which payment cards are used, the fraud detection engine 230 may identify two or more financial transactions in which the payment cards that were used have the same partial code. In another example, assuming the identification events relate to user identification events in which users 204 authenticate themselves using ID tags, the fraud detection engine 230 may identify two or more user identification events in which the ID tags that were used have the same partial code.

Obviously, the fact that the ID items 202 used in a plurality of identification events have the same partial code does not necessarily imply that this is the same ID item 202 since the same partial code may be shared by a plurality of ID items 202.

The fraud detection engine 230 may therefore try to estimate whether the same ID item 202 was used in multiple identification events or were these different II items 202 which happen to have the same partial code based on a time period which elapsed between identification events, i.e., first and second events, in which ID items 202 having the same partial code were used.

As shown at 106, the fraud detection engine 230 may compute and/or measure the time period which elapsed between each of the first identification events and one or more corresponding subsequent second identification events in which the used ID items have the same partial code.

The fraud detection engine 230 may extract the timing data, for example, the timestamp associated with each of the identification events in the identification events data 206 and may compute and/or measure accordingly the time period (gap) between each first identification event and each corresponding subsequent second identification event.

The fraud detection engine 230 may then compare between the time period, measured the first and second identification events of each pair, and a certain threshold, expressing a certain time interval, for example, a second, a minute, 15 minutes, an hour, 6 hours, a day, and/or the like.

Optionally, the fraud detection engine 230 may compute the time period between the first identification event of one or more pairs and their corresponding subsequent second identification events in real-time immediately following the occurrence of the identification events.

As shown at 108, which is a conditional step, in case the time period measured between the first identification event of a respective pair and its corresponding subsequent second identification event does not exceed the certain time interval, the fraud detection engine 230 may branch to 110. Otherwise, in case the time period measured between the first identification event of the respective pair and its corresponding subsequent second identification event exceeds the certain time interval, the fraud detection engine 230 may branch to 114.

As shown at 110, since the time period measured between the respective first identification event and its corresponding subsequent second identification event does not exceed the certain time interval (threshold), the fraud detection engine 230 may estimate and/or determine that the ID item 202 used in the respective first identification event is the same ID item 202 used in the respective second identification event, i.e., the corresponding subsequent second identification event.

The use of the same ID item 202 in multiple identification events spaced from each other by significantly short time intervals may be indicative of possible fraudulent use of the ID item 202 since it is usually unlikely for the same user 206 to use his associated ID item at such high frequency and within a short time period. Rather, such usage pattern of the ID item 202 may be typical to fraudulent use of the ID item 202 by a fraudulent party attempting to gain access, steal, and/or otherwise compromise identify and/or resources of the user 206.

As shown at 112, the fraud detection engine 230 may generate one or more notifications indicative of a potential fraudulent use of the same ID item 202.

For example, the fraud detection engine 230 may transmit, via the network 212, one or more notifications, alerts, and/or warning messages to one or more systems, and/or personnel used and/or assigned to monitor, handle, and/or take further action in the event of potential fraudulent use of the ID items 202. Such systems may include, for example, a security system of an issuer of the payment cards, a security team of a secure facility, and/or the like.

As shown at 114, since the time period measured between the respective first identification event and its corresponding subsequent second identification event exceeds the certain time interval (threshold), the fraud detection engine 230 may estimate and/or determine that the ID item 202 used in the respective first identification event is not the same ID item 202 used in the respective second identification event, i.e., the corresponding subsequent second identification event.

This means that fraud detection engine 230 may estimate and/or determine that the ID item 202 used in the respective first identification and the ID item 202 used in the corresponding subsequent second identification event are different from each other even though they may have an identical partial code.

In such case the fraud detection engine 230 may take no action. Optionally, the fraud detection engine 230 may transmit one or more notifications, and/or messages indicating no suspicious usage of the ID items 202 was detected for one or more evaluated pairs of a first identification event and corresponding subsequent second event(s).

The certain time interval used for estimating whether the same ID item 202 or different ID items 202 were used in multiple identification events may be selected, set, defined, predefined, and/or adjusted according to parameters, attributes, and/or characteristics relating to the identification events, the ID items 202, the application for which the ID items 202 are used, and/or the like.

For example, the certain time interval may be set, and/or defined based on a statistical analysis of a frequency of a plurality of identification events conducted using at least some of the plurality of ID items 202. For example, assuming the plurality of ID items 202 are payment cards, based on a statistical analysis of a plurality of identification events, specifically financial transactions made using the payment cards, it may be determined that frequency of identification events is extremely high and the certain time interval may be set to a relatively short time interval, for example, 10 minutes. In another example, assuming the plurality of ID items 202 are ID tags, based on a statistical analysis of a plurality of user identification events conducted using the ID tags, it may be determined that frequency of identification events is significantly low, and the certain time interval may be set to a relatively long time interval, for example, 3 hours.

Moreover, the certain time interval may be set, and/or adjusted according to an estimation error tolerance expressing a wrong estimation of whether the same ID item 202 or different ID items 202 having the same partial code were used in multiple identification events. For example, assuming the target estimation error is 1%, meaning that only 1 out of a 100 estimations in which two different ID items 202 having the same partial code are estimated to be the same ID may be wrong. In such case, this tolerance level may be applied to define, and/or adjust the certain time interval to achieve and/or maintain this 1% error rate.

In another example, the certain time interval may be set, defined and/or adjusted for each of a plurality of issuers of the ID items 202. For example, a shorter time interval may be set for a first payment card issuer having a large number of payment cards on the market which are used highly frequent while a longer time interval may be set for a second payment card issuer having significantly less payment cards on the market which are used in lower frequency. In another example, a shorter time interval may be set for a first online merchant, verifying users' ID items 202 for online access and/or purchase, who enforces a more strict security policy for fraud enforcement compared to a longer time interval set for a second online merchant enforcing a less strict fraud enforcement policy.

In another example, the certain time interval may be set, defined and/or adjusted according to one or more attributes of the plurality of identification events, the application, service, and/or platform for which the ID items 202 identification is used, and/or the ID items 202 themselves. For example, assuming the ID items 202 are payment cards used for making financial transactions and the frequency of such financial transactions is extremely high, for example, hundreds of transactions a minute. In such case, the selected time interval may be significantly short, for example, 15 minutes. In another example, assuming the ID items 202 are ID tags for verifying identify of users 206 before admitting them into a secure facility where they are typically stay for a significant long time, for example, a 10 hours shift. In such case, the selected time interval may be significantly long, for example, 2 hours.

Optionally, the fraud detection engine 230 may be further adapted to estimate whether the ID item 202 used in one or more pairs of first identification event and a corresponding second identifications event is the same ID item 202 or a different one based on one or more additional ID items 202 associated with the ID item 202.

For example, assuming that a certain payment card is associated with a certain user who is further associated with a certain account ID, for example, a certain email address. Further assuming that in a certain first identification event and a corresponding subsequent second identification event, the account ID associated with the payment card, i.e., the email address of the certain user is also exposed, for example, to establish a contact cannel with the certain user. In such case, in addition to the partial code number and elapsed time period estimation, the fraud detection engine 230 may further base the estimation of whether the same payment card was used in the first and second identification events based on whether the account ID, i.e., email address used in these identification events is the same (identical) email address or a different one. In case, the partial code of the payment cards used in the first and second identification events is the same partial and the email address provided by the users in these identification events is also the same, the fraud detection engine 230 may estimate with increased accuracy, certainty, and/or reliability that payment card used in these identification events is the same. Otherwise, in case the partial code of the payment cards used in these first and second identification events is the same but the email address provided are different, the fraud detection engine 230 may re-evaluate its estimation and potentially reverse it, reduce a probability of correct estimation and/or the like.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms ID items and token based protocols are intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A method for improving a functioning and increasing immunity against cyberattacks of a system for detecting potential fraudulent use of identification (ID) items, comprising:
using at least one processor of a fraud detection system for detection of potential fraudulent use of identification (ID) items which are members of a group consisting of payments cards, user ID tags, keys and fobs, said fraud detection system is connected through a communication network to at least one remote system which manages and/or controls identification and/or authentication of users using ID items in identification events, for:
receiving, over said communication network, from said at least one remote system, only a partial code associated with each of a plurality of ID items used for identification in said plurality of identification events, where each identification event is associated with timing data, wherein each ID item is associated with a different unique code and wherein the partial code is a segment of the unique code, said segment is the only segment of the unique code that is publicly exposed by said ID items during said plurality of identification events, wherein a rest of said unique code is not publicly exposed by said ID items during said plurality of identification events, and wherein said unique code is not being accessed or stored by said at least one processor, thereby improving the functioning and increasing the immunity of said fraud detection system by preventing cyberattack attempts on said fraud detection system for gaining access to said unique code;
identifying at least one first identification event and at least one second identification event of the plurality of identification events, when an ID item used for identification in said at least one first identification event and an ID item used for identification in said at least one second identification event, have an identical partial code;
estimating that the ID item used in the at least one first identification event and the ID item used in the at least one second identification event are different ID items when a time period between the first identification event and the second identification event exceeds a predefined time interval;
estimating that the ID item used in the at least one first identification event is the same ID item used in the at least one second identification event when the time period does not exceed the predefined time interval;
generating, responsive to estimating that the same ID item is used in the at least one first and in the at least one second identification events, at least one notification indicative of a potential fraudulent use of the same ID item; and
transmitting said at least one notification, over said communication network, to said at least one remote system.

2. The method of claim 1, wherein the plurality of ID items comprise a plurality of payment cards used in a plurality of financial transactions, the unique code associated with each of the plurality of payment cards comprises a primary account number (PAN) code comprising a string of digits, and the partial code of each of the plurality of payment cards comprises part of the string of digits of the PAN of the respective payment card.

3. The method of claim 2, wherein the partial code of at least some of the plurality of payment cards further comprises a bank identification number (BIN) and/or an issuer identification number (IIN) of the respective payment card.

4. The method of claim 2, wherein the partial code of each of the plurality of payment cards further comprises an expiration date of the respective payment card.

5. The method of claim 1, wherein the plurality of ID items comprises a plurality of user ID tags associated with a plurality of users used in a plurality of user identification events.

6. The method of claim 1, wherein the plurality of ID items comprises a plurality of account IDs associated with a plurality of users and used in a plurality of user identification events.

7. The method of claim 1, wherein the predefined time interval is predefined based on a statistical analysis of a frequency of a plurality of identification events conducted using at least some of the plurality of ID items.

8. The method of claim 7, wherein the predefined time interval is adjusted according to an estimation error tolerance.

9. The method of claim 1, wherein the plurality of ID items are issued by a plurality of issuers, the predefined time interval is predefined respectively for each of the plurality of issuers.

10. The method of claim 1, wherein the predefined time interval is predefined according to at least one attribute of the plurality of identification events.

11. The method of claim 1, further comprising estimating whether the ID item used in the at least one first identification event is the same ID item used in the at least one second identification event or a different ID item based on at least one additional ID item associated with the ID item.

12. A system for detecting potential fraudulent use of identification (ID) items, with increased immunity against cyberattacks, comprising:
a network interface connected to a communication network and that connects said system, through said communication network, to at least one remote system which manages and/or controls identification and/or authentication of users using identification ID items in identification events, said ID items are members of a group consisting of payments cards, user ID tags, keys and fobs;
at least one processor configured to execute a code, the code comprising:
code instructions to receive, over said communication network, from said at least one remote system, only a partial code associated with each of a plurality of ID items used for identification in said plurality of identification events, where each identification event is associated with timing data, wherein each ID item is associated with a different unique code and wherein the partial code is a segment of the unique code, said segment is the only segment of the unique code that is publicly exposed by said ID items during said plurality of identification events wherein a rest of said unique code is not publicly exposed by said ID items during said plurality of identification events, and wherein said unique code is not being accessed or stored by said at least one processor, thereby improving the functioning and increasing the immunity of said fraud detection system by preventing cyberattack attempts on said system for gaining access to said unique code;
code instructions to identify at least one first identification event and at least one second identification event of the plurality of identification events, when an ID item used for identification in said at least one first identification event and an ID item used for identification in said at least one second identification event, have an identical partial code;
code instructions to estimate that the ID item used in the at least one first identification event and the ID item used in the at least one second identification event are different ID items when a time period between the first identification event and the second identification event exceeds a predefined time interval;
code instructions to estimate that the ID item used in the at least one first identification event is the same ID item used in the at least one second identification event when the time period does not exceed the predefined time interval;
code instructions to generate, responsive to estimating that the same ID item is used in the at least one first and in the at least one second identification events, at least one notification indicative of a potential fraudulent use of the same ID item; and
code instructions to transmit said at least one notification, over said communication network, to said at least one remote system.

13. The system of claim 12, wherein the plurality of ID items comprise a plurality of payment cards used in a plurality of financial transactions, the unique code associated with each of the plurality of payment cards comprises a primary account number (PAN) code comprising a string of digits, and the partial code of each of the plurality of payment cards comprises part of the string of digits of the PAN of the respective payment card.

14. The system of claim 13, wherein the partial code of at least some of the plurality of payment cards further comprises a bank identification number (BIN) and/or an issuer identification number (IIN) of the respective payment card.

15. The system of claim 13, wherein the partial code of each of the plurality of payment cards further comprises an expiration date of the respective payment card.

16. The system of claim 12, wherein the plurality of ID items comprise a plurality of user ID tags used in a plurality of user identification events.

17. The system of claim 12, wherein the plurality of ID items comprises a plurality of account IDs associated with a plurality of users and used in a plurality of user identification events.

18. The system of claim 12, wherein the predefined time interval is predefined based on a statistical analysis of a frequency of plurality of identification events conducted using at least some of the plurality of ID items.

19. The system of claim 18, wherein the predefined time interval is adjusted according to a predefined estimation error tolerance.

20. The system of claim 12, further comprising estimating whether the ID item used in the at least one first identification event is the same ID item used in the at least one second identification event or a different ID item based on at least one additional ID item associated with the ID item.
